(19) United States
(12) Patent Application Publication
(10) Pub. No.: US 2008/0308573 A1
(43) Pub. Date: Dec. 18, 2008

(54) Adjustable Product Holder

(75) Inventors: Dennis Parham, Kennesaw, GA (US); David Stoddard, Smyrna, GA (US); John Orgeron, Marietta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PROFITMASTER DISPLAYS, INC., Atlanta, GA (US)

(21) Appl. No.: 11/764,272

(22) Filed: Jun. 18, 2007

(51) Int. Cl. G07F 11/00

(52) U.S. Cl. 221/131

(57) ABSTRACT

A product holder includes a support mechanism configured to support one or more products, a mounting mechanism configured to couple the support mechanism to a surface, and a depth adjustment mechanism configured to enable repositioning the support mechanism in a depth direction, the depth direction being generally perpendicular to the surface.

### TECHNICAL FIELD

The present disclosure generally relates to a system for holding beverage containers and more particularly relates to an adjustable system for holding beverage containers.

### BACKGROUND

Product holders are commonly employed in retail establishments to display products for purchase. One type of product holder is designed to be coupled to a surface, such as a glass door surface. For example, coolers of the type commonly found in convenience stores often have glass doors so that products inside the cooler can be viewed by customers while being cooled. In such cases, a product holder can be mounted at eye level on an interior surface of the glass door so that new or featured products placed in the product holder can be showcased for passing customers while being cooled by the cooler.

Most product holders have fixed dimensions and are not adjustable. Due to the fixed dimensions, the product holder can display products having some dimensions, but not others. Further, the fixed dimensions of the product holder limit the maximum number of products that can be displayed. For example, a product holder designed to be used with a cooler may be sized to display a predetermined number of twelve-ounce beverage cans. However, the product holder may be too small for additional cans and/or containers of larger sizes.

In limited cases, product holders are adjustable in width so that additional products can be displayed as desired. However, because the depth of such product holders cannot be adjusted, displaying products of other dimensions is not possible. Thus, a need exists for an adjustable product holder that can be used to display products of varying shapes and sizes.

### SUMMARY

In embodiments, a product holder includes a support mechanism configured to support one or more products, a mounting mechanism configured to couple the support mechanism to a surface, and a depth adjustment mechanism configured to enable repositioning the support mechanism in a depth direction, the depth direction being generally perpendicular to the surface.

In embodiments, a product holder includes a support mechanism, a depth adjustment mechanism, and a mounting mechanism. The support mechanism can support one or more products. The mounting mechanism can be mounted to a surface. The depth adjustment mechanism couples the support mechanism to the mounting mechanism. The depth adjustment mechanism is movable with reference to the support mechanism to reposition the support mechanism in a depth direction, the depth direction being generally perpendicular to the surface.

Other systems, devices, methods, features, and advantages of the disclosed product holder will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE FIGURES

The present disclosure may be better understood with reference to the following figures. Matching reference numerals designate corresponding parts throughout the figures, and components in the figures are not necessarily to scale.

FIG. 1 is a perspective view of an embodiment of a product holder.

FIG. 2 is a perspective view of the embodiment of the product holder shown in FIG. 1, illustrating the product holder coupled to a glass door of a cooler.

FIG. 3 is an exploded perspective view of a support mechanism of the product holder shown in FIG. 1.

FIG. 4 is an exploded perspective view of a depth adjustment mechanism of the product holder shown in FIG. 1.

### DETAILED DESCRIPTION

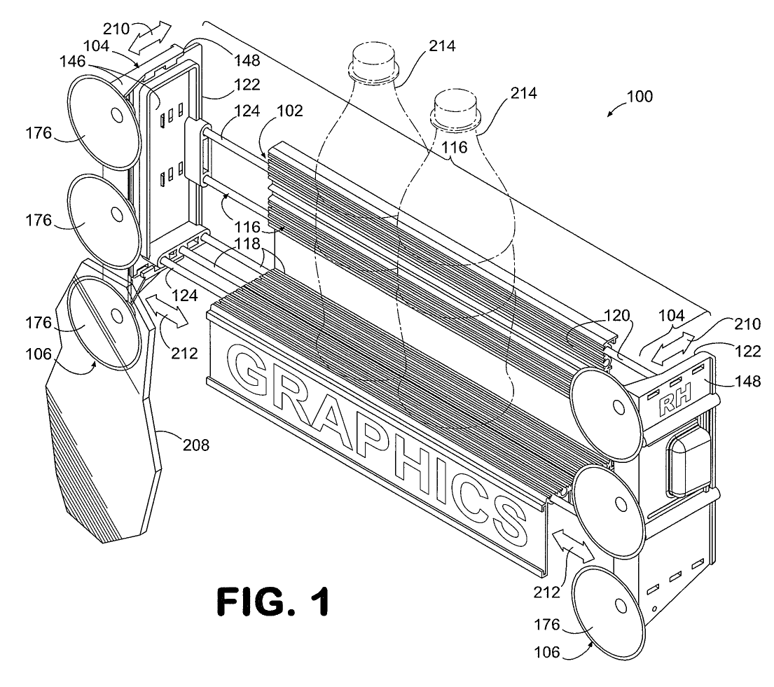

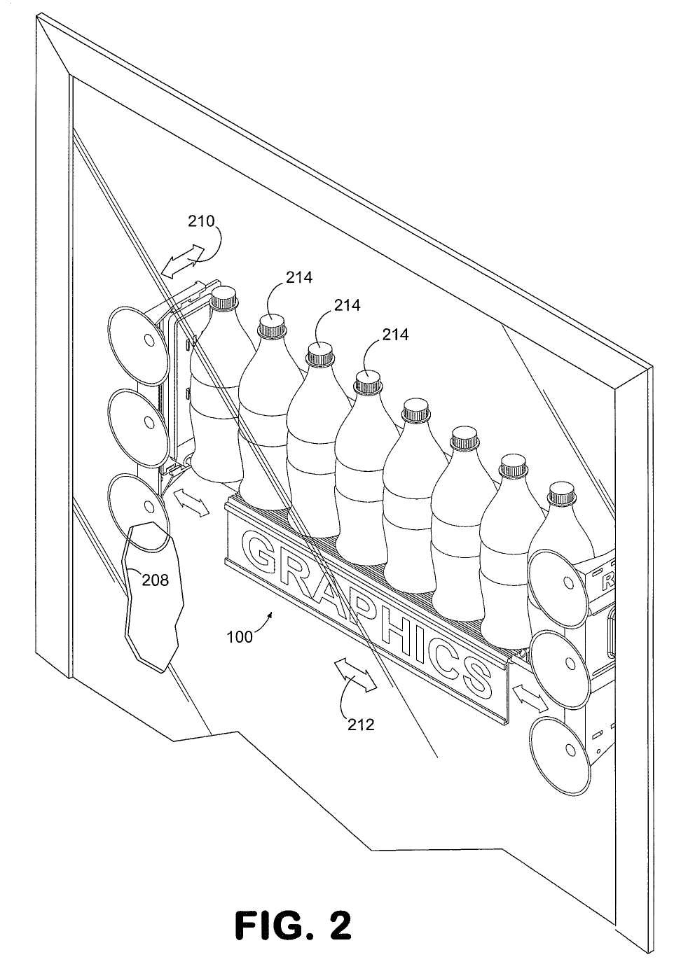

FIG. 1 is a perspective view of an embodiment of a product holder 100, and FIG. 2 is a perspective view of the product holder 100, illustrating an exemplary use of the product holder. As shown in FIG. 1, the product holder 100 includes a support mechanism 102, a depth adjustment mechanism 104, and a mounting mechanism 106. As shown in FIG. 2, the support mechanism 102 is configured to support one or more products 214. As shown in FIG. 1, the mounting mechanism 106 is configured to couple the support mechanism 102 to a surface 208. The depth adjustment mechanism 104 is configured to enable repositioning the support mechanism 102 in a depth direction 210, so that the product holder 100 can support products 214 of varying dimensions. In the illustrated embodiment, the product holder 100 further includes a width adjustment mechanism 116 configured to enable adjusting the support mechanism 102 in a width direction 212, so that the product holder 100 can support additional products 214 or can be coupled to surfaces 208 of varying dimensions, although the width adjustment mechanism 116 can be omitted.

More specifically, the product holder 100 is shown coupled to a surface 208 that is glass, such as a glass door of the type commonly found on a cooler in a convenience store. The product holder 100 supports products 214 that are containers, such as twelve-ounce beverage cans of the type commonly sold in a convenience store. When used as shown, the product holder 100 supports and displays the beverage containers to passing customers. The depth adjustment mechanism 104 can be used to adjust the relative position of the support mechanism 102 with respect to the surface 208, so that the product holder 100 can support products 214 of varying dimensions, such as beverage containers other than twelve-ounce beverage cans. However, the product holder 100 can be employed in manners other than the manner shown in FIG. 2.

In this disclosure, terms such as width, depth, forward, rearward, upper, and lower, among others, are used to provide a relative frame of reference for explanatory purposes and are not intended to limit the disclosure. For example, the term depth direction 210 generally denotes a direction that is substantially perpendicular to a longitudinal width of the product holder 100, while the term width direction 212 generally denotes a direction that is substantially parallel to the longitudinal width of the product holder 100. The term forward generally denotes a position that is relatively closer to the mounting mechanism 106, while the term rearward denotes a position that is relative farther away from the mounting mechanism 106. The term lower generally denotes a position that is relatively closer to the ground when the product holder 100 is positioned in the intended orientation, and the term upper generally denotes a position that is relatively farther from the ground when the product holder 100 is positioned in the intended orientation. Therefore, when the product holder 100 is coupled to the surface 208 in the intended orientation, the depth direction 210 is substantially perpendicular to the surface 208, the width direction 212 is substantially parallel to the surface 208, the forward side of the product holder 100 is relatively closer to the surface 208 than the rearward side of the product holder 100, and the lower side of the product holder 100 is relatively closer to the ground than the upper side of the product holder 100.

With reference back to FIG. 1, the support mechanism 102 is configured to support a weight of the products 214 and to retain the products 214 in an upright position. The support mechanism 102 includes one or more lower support portions 118, one or more rearward support portions 120, and one or more side support portions 122. Each lower support portion 118 is configured to support the weight of at least some of the products 214 from below. Each rearward support portion 120 is configured to stabilize at least some of the products 214 so that the products 214 do not tip rearward in the depth direction 210. Each side support portion 122 is configured to stabilize at least some of the products 214 so that the products 214 do not tip outward in the width direction 212. In other words, the rearward and side support portions 120, 122 restrict a moment of the products 214. In the illustrated embodiment, a tendency of the products 214 to tip forward in the depth direction 210 is limited by the surface 208 to which the product holder 100 is mounted, although in other embodiments a forward support portion may be provided for this purpose.

The width adjustment mechanism 116 enables adjusting the support mechanism 102 in a width direction 212, so that the product holder 100 can support additional products 214 and the product holder 100 can be mounted to surfaces 208 having a range of dimensions. For example, the support mechanism 102 may include at least two width telescoping portions 124 that are movable with respect to each other in the width direction 212 to adjust the width of the support mechanism 102.

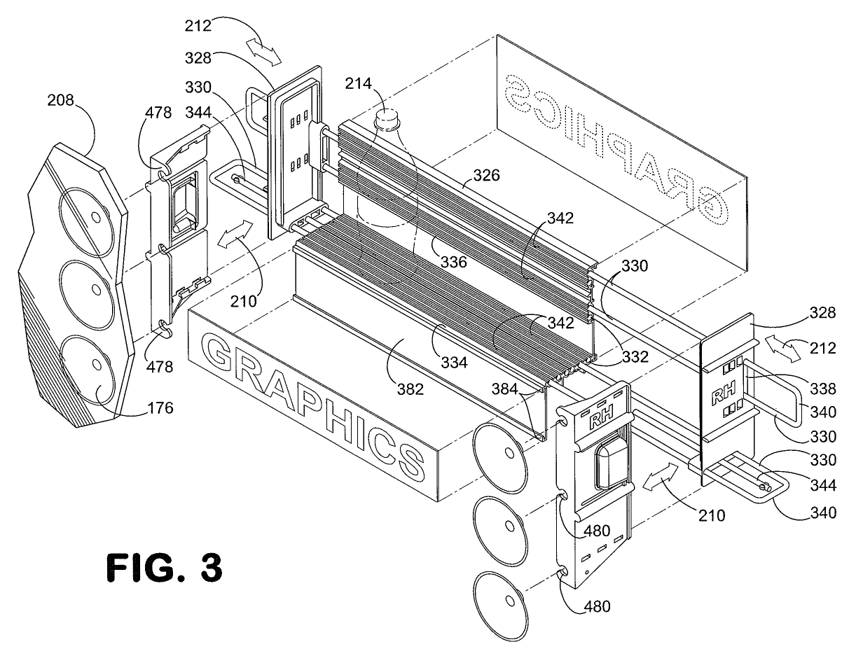

FIG. 3 is an exploded perspective view of the support mechanism 102, illustrating the width adjustment mechanism 116 in greater detail. As shown, the support mechanism 102 includes three width telescoping portions 124. One width telescoping portion 124 is formed from a central L-shaped member 326, and each of the other width telescoping portions 124 are formed from a side plate 328 coupled to a plurality of extension members 330. The side plates 328 are positioned on opposite sides of the central L-shaped member 326 such that the extension members 330 extend inward from the side plates 328 toward the central L-shaped member 326. A plurality of channels 332 extend through the central L-shaped member 326 in the width direction 212, and the channels 332 are sized and shaped to receive the extension members 330. When the product holder 100 is assembled, the extension members 330 can slide into and out of the channels 332 to adjust the support mechanism 102 in the width direction 212.

More specifically, the central L-shaped member 326 has a lower surface 334 and a rearward surface 336, the surfaces 334, 336 being positioned at right angles with respect to each other. The channels 332 are formed through the surfaces 334, 336 and are truncated on inward sides so that the surfaces 334, 336 are relatively level and products 214 resting on or against the surfaces 334, 336 do not tip. In the illustrated embodiment, four channels 332 are formed through the rearward surface 336 and six channels 332 are formed through the lower surface 334 for reasons described below, although other configurations are possible.

The side plates 328 are coupled to the extension members 330 using extension member couplings 338. The extension member couplings 338 have openings for receiving the extension members 330, and extend inward from the side plates 328 to stabilize the extension members 330 substantially perpendicularly to the side plates 328. Each extension member 330 has an outer end 340 configured to be positioned in extension member coupling 338, and an inner end 342 configured to be slidably positioned in one of the channels 332.

The extension member couplings 338 on one of the side plates 328 are offset from the extension member couplings 338 on the other side plate 328 so that the extension members 330 on opposite sides of the central L-shaped member 326 are spaced apart from each other. Each extension member 330 is received in a separate channel 332 and is interleaved or interwoven with the other extension members 330 in the other channels 332. Thus, each extension member 330 can extend more than half of the length of the central L-shaped member 326 without interfering with the extension member 330 on the other side of the product holder 100, increasing stability. In other embodiments, the extension members 330 may not be interleaved, in which case the extension members 330 on opposite sides may share channels 332 and half of the channels 332 may be omitted.

In the illustrated embodiment, the extension members 330 are U-shaped wires. Each U-shaped wire has a U-shaped outer end 340 that snap-fits into one of the extension member couplings 338 and two legs that form the extension members 330. Each leg has an inner end 342 that can be slidably positioned in one of the channels 332. However, other configurations are possible.

In some embodiments, the width adjustment mechanism 116 can be locked at a specifically selected width. In the illustrated embodiment, the width of the support mechanism 102 is fixed by mounting the product holder 100 to the surface 208 using the mounting mechanism 106, which fixes the distance between the side plates 328. In other embodiments, a locking mechanism (not shown) may be provided that locks the width adjustment mechanism 116. Although the width adjustment mechanism 116 is described above as having a specific configuration, in other embodiments, the width adjustment mechanism 116 may have other configurations or may be omitted completely.

As mentioned above, the support mechanism 102 includes rearward support portions 120, side support portions 122, and lower support portions 118. In the illustrated embodiment, the rearward surface 336 of the central L-shaped member 326 and the extension members 330 extending through the rearward surface 336 form the rearward support portions 120. The side plates 328 form the side support portions 122. The lower support portions 118 include the lower surface 334 of the central L-shaped member 326 and the extension members 330 extending through the lower surface 334.

In some embodiments, the support mechanism 102 may include additional lower support portions 118. For example, one or more supplemental support members 344 may extend from the extension member couplings 338 into the channels 332. The supplemental support members 344 may be oriented to support products 214 of specific shapes. For example, in the illustrated embodiment, the extension members 330 and supplemental support members 344 are spaced apart in an arrangement that is suited to support a beverage container having a petaloid-shaped lower surface.

In some embodiments, the support mechanism 102 further includes an excessive width indicator. For example, one or more of the supplemental support members 344 may have a pre-selected length. The length is pre-selected such that when the support mechanism 102 is adjusted to a reasonable width, the supplemental support member 344 spans the distance from one of the side plates 328 to the central L-shaped member 326. When the support mechanism 102 is adjusted to an excessive width, the supplemental support member 344 is not long enough to span the distance and an inner end of the supplemental support member 344 becomes removed from the channel 332 to indicate the excessive width condition. For example, an excessive width condition may be indicated when the mounting mechanism 106 could not support the anticipated load. In other embodiments, the excessive width indicator may have other configurations or may be omitted completely.

With reference back to FIG. 1, the product holder 100 further includes the depth adjustment mechanism 104. The depth adjustment mechanism 104 couples the support mechanism 102 to the mounting mechanism 106, and can be moved to reposition the support mechanism 102 relative to the mounting mechanism 106, so that the product holder 100 can support products 214 of varying dimensions. When the mounting mechanism 106 is coupled to the surface 208, the support mechanism 102 can be repositioned relatively closer to or farther from the surface 208, as desired. In some embodiments, the depth adjustment mechanism 104 includes at least two depth telescoping portions 146 that are movable with respect to each other in the depth direction 210 to adjust the depth of the product holder 100, although other configurations are possible.

In some cases, the depth adjustment mechanism 104 is incrementally adjustable so that the support mechanism 102 can be adjusted to one of a number of pre-selected depth positions, while in other cases, the depth adjustment mechanism 104 is continuously adjustable so that the support mechanism 102 can adjusted to any position along a range of depth positions. In either case, the depth adjustment mechanism 104 is configured to be releasably locked at the selected depth position, so that products 214 can be safely loaded into the product holder 100.

In the illustrated embodiment, the depth adjustment mechanism 104 can be incrementally adjusted to one of three pre-selected depth positions. The pre-selected depth positions correspond to conventional beverage container sizes so that the product holder 100 is suited for displaying beverage containers of varying sizes, as shown in FIG. 2. In a first pre-selected depth position, a forward side of the rearward surface 336 of the support mechanism 102 is about 2 15/16 inches from a forward surface of the mounting mechanism 106, so that the product holder 100 can display products 214 having a dimension between about 2¾ inches and about 2⅞ inches in the depth direction 210. For example, the first pre-selected depth position is suited to display 20-ounce beverage bottles and 24-ounce beverage cans, which typically have diameters in the range of about 2¾ inches to 2⅞ inches. In a second pre-selected depth position, a forward side of the rearward surface 336 of the support mechanism 102 is about 2 11/16 inches from a forward surface of the mounting mechanism 106, so that the product holder 100 can display products 214 having a dimensions between about 2½ inches and about 2⅝ inches in the depth direction 210. For example, the second pre-selected depth position is suited to display 16-ounce beverage cans, which typically have diameters in the range of about 2⅝ inches. In a third pre-selected depth position, a forward side of the rearward surface 336 of the support mechanism 102 is about 2 5/16 inches from a forward surface of the mounting mechanism 106, so that the product holder 100 can display products 214 having a dimension of up to 2¼ inches in the depth direction 210. For example, the third pre-selected depth position is suited to display slim cans of the type commonly employed to contain energy or performance drinks, which typically have diameters of about 2¼ inches. Of course, the illustrated depth adjustment mechanism 104 is described by way of example, and in other embodiments, the principles of the present disclosure can be applied to product holders 100 suited for other particular applications, as desired.

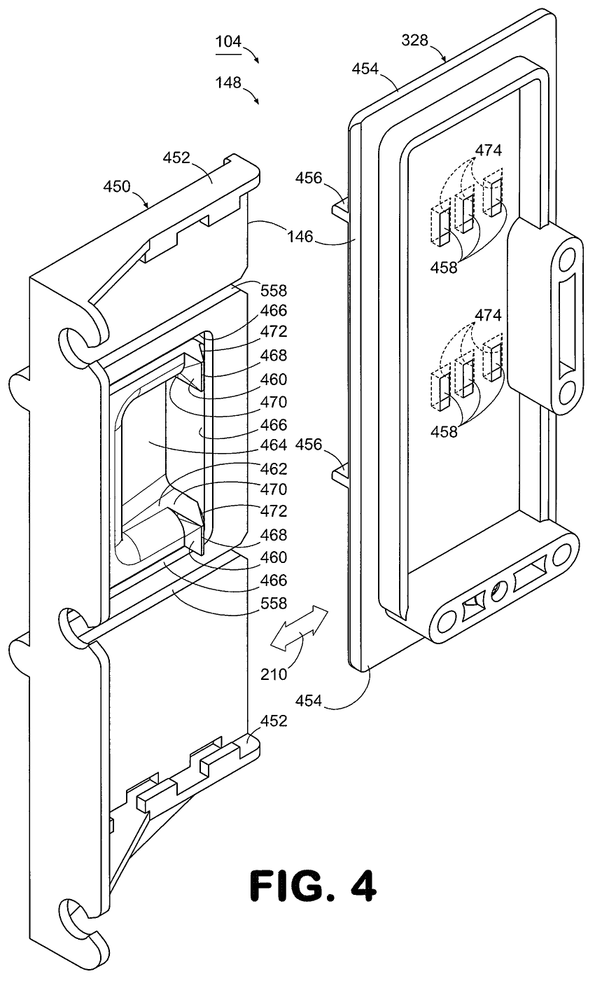

FIG. 4 is an exploded perspective view of a depth adjustment mechanism 104 of the product holder 100 shown in FIG. 1. As shown, the depth adjustment mechanism 104 includes two depth adjusters 148. The depth adjusters 148 are located on opposite ends of the product holder 100 and are substantially mirror images of each other. Each depth adjuster 148 includes two depth telescoping portions 146. A first depth telescoping portion 146 is formed from the side plate 328 of the support mechanism 102, and second depth telescoping portion 146 is a depth adjustment plate 450 positioned outward of the side plate 328. The plates 328, 450 may be relative planar and are slidably positioned adjacent each other. Each plate 328, 450 is oriented on a plane that is substantially parallel to the depth direction 210, although other configurations are possible.

As mentioned above, the depth adjustment mechanism 104 couples the support mechanism 102 to the mounting mechanism 106. More specifically, the side plate 328 of each depth adjuster 148 is coupled to the support mechanism 102, while the depth adjustment plate 450 of each depth adjuster 148 is coupled to the mounting mechanism 106. Therefore, the position of the support mechanism 102 with reference to the mounting mechanism 106 can be adjusted by adjusting the position of the side plate 328 with reference to the depth adjustment plate 450. Either or both of the plates 328, 450 can be moved to adjust the product holder 100 in the depth direction 210. For example, the side plate 328 can be held stationary, and the depth adjustment plate 450 can be moved in the depth direction 210, or both plates 328, 450 can be moved simultaneously. Alternatively, when the product holder 100 is mounted to the surface 208, the depth adjustment plate 450 is held stationary by the mounting mechanism 106, and the side plate 328 can be moved in the depth direction 210.

The depth adjustment mechanism 104 is configured to retain the depth telescoping portions 146 in alignment as the depth is adjusted. For example, upper and lower flanges 452 on the depth adjustment plate 450 are configured to receive upper and lower edges 454 of the side plate 328, and tracks 456 extending along the side plate 328 in the depth direction 210 are configured to mate with corresponding slots 558 extending along the depth adjustment plate 450 in the depth direction 210. As the depth is adjusted, the flanges 452 on the depth adjustment plates 450 cooperate with the edges 454 on the side plates 328 and the tracks 456 on the depth adjustment plates 450 cooperate with the slots 558 on the side plates 328 to maintain the plates 328, 450 in alignment.

The depth adjustment mechanism 104 can be incrementally adjusted to pre-selected depth positions in some embodiments, and is further configured to releasable lock at the selected depth position. The side plate 328 has a plurality of apertures 458 spaced in an arrangement corresponding to the pre-selected depth positions, and the depth adjustment plate 450 has at least one tooth 460 configured to releasably engage any one of the apertures 458 to releasably lock the plates 328, 450 together. To reposition the plates 328, 450, the depth adjustment plate 450 has a deformable tab 462 coupled to the tooth 460 that actuates the tooth 460. Specifically, engaging the deformable tab 462 removes the tooth 460 from the aperture 458 so that the plates 328, 450 can be repositioned, and disengaging the deformable tab 462 positions the tooth 460 in the aperture 458 to lock the plates 328, 450 in position.

In the illustrated embodiment, the side plate 328 has two sets of apertures 458 arranged in rows extending in the depth direction, and the deformable tab has two teeth 460. Although not necessary, providing two sets of apertures 458 and two teeth 460 may assist with maintaining the plates 328, 450 in alignment during use. More specifically, a finger pull 464 shaped for receiving several fingers is molded into the deformable tab 462, and a U-shaped opening 466 surrounds the deformable tab 462. The teeth 460 are coupled to an inner side of the deformable tab 462 on either side of the finger pull 464 between the finger pull 464 and the U-shaped opening 466, so that actuation of the deformable tab 462 simultaneously actuates the teeth 460 in a corresponding direction. The deformable tab 462 flexes away from the product holder 100 when the finger pull 464 is pulled outward, and naturally returns toward the product holder 100 when the outward pressure is released. Each tooth 460 has a distal end 468 sized and shaped to fit into the aperture 458 with relative ease, and a proximal end 470 sized and shaped to catch against the aperture 458. An angled surface 472 connecting the proximal and distal ends 466, 468 is configured to guide the tooth 460 into the aperture 458 and to mate with an angled surface 474 on the aperture 458.

To adjust the depth, the deformable tab 462 is actuated to remove the tooth 460 from the aperture 458. The depth adjustment plate 450 is then moved in the depth direction 210 until the tooth 460 is in the generally adjacent aperture 458 corresponding to the selected depth position. The deformable tab 462 is released, and the proximal end 470 of the tooth 460 enters the aperture 458. The angled surface 472 of the tooth 460 guides the tooth 460 into the aperture 458, and mates with the angled surface 474 on the aperture 458. The tooth 460 then catches against the aperture 458 to retain the tooth 460 in the aperture 458.

Although the depth adjustment mechanism 104 is described above as having a specific configuration, in other embodiments, the depth adjustment mechanism 104 may have other configurations. For example, the side plate 328 of the support mechanism 102 also serves as one of the depth telescoping portions 146 of the depth adjustment mechanism 104 in the illustrated embodiment. In other embodiments, the side plate 328 may not form part of the depth adjustment mechanism 104, in which case the side plate 328 may be coupled to one of the depth telescoping portions 146 of the depth adjustment mechanism 104. As another example, the plates 328, 450 are substantially perpendicular to the surface 208 in the illustrated embodiment, and therefore the support mechanism 102 is adjusted in a direction that is substantially perpendicular to the depth direction 210. In other embodiments, the plates 328, 450 may form an angle with the surface 208, in which case the support mechanism 102 is adjusted in a direction having a component in the depth direction 210 and a component in the width direction 212. Further, the depth telescoping portions 146 need not be plates, and the depth telescoping portions 146 can be maintained in alignment in other manners, including by manually maintaining the alignment during depth adjustment. Still other configurations are contemplated based on the present disclosure.

With reference back to FIG. 1, the mounting mechanism 106 is configured to mount the product holder 100 to the surface 208 so that the product holder 100 is relatively level with the ground. For example, the mounting mechanism 106 may include a plurality of mounting elements 176 that are positioned on a forward face of the product holder 100, so that the load of the products 214 is distributed across multiple mounting points. The mounting elements 176 may be positioned so that the load is distributed relatively evenly, and the product holder 100 is supported relatively level to the ground. For example, the mounting elements 176 may be symmetrically positioned on the forward face of the product holder 100. The mounting mechanism 106 may be releasable, so that that the product holder 100 can selectively couple to and release from the surface 208. In such cases, the mounting mechanism 106 is configured to remain mounted under the load of the products 214 placed in the product holder 100. Alternatively, the mounting mechanism 106 may not be releasable, so that the product holder 100 is fixed to the surface 208.

An embodiment of the mounting mechanism 106 is illustrated in greater detail in FIG. 3. As shown, a plurality of mounting elements 176 are provided. The mounting elements 176 are coupled to forward surfaces of the depth adjustment plates 450, each mounting element 176 being coupled to one of the depth adjustment plates 450, and each depth adjustment plate 450 being coupled to at least one mounting element 176. More specifically, the depth adjustment plates 450 have forward flanges 478 that project in the width direction 212, and a plurality of receiving apertures 480 are formed through the forward flanges 478. Each receiving aperture 480 has a narrow neck that can form a snap fitting with a connector (not shown) on a rearward side of the mounting element 176. In FIG. 3, each depth adjustment plate 450 has three receiving apertures 480. The central receiving aperture 480 could be left empty without a coupled mounting element 176 if it is not necessary to assist in bearing the load of particularly heavy products 214. As shown, the mounting elements 176 are suction cups that are configured to seal with the surface 208 upon the application of forward pressure, and to release from the surface 208 upon the application of rearward pressure, although other configurations are possible. However, the illustrated mounting mechanism 106 is disclosed by way of example, and in other embodiments the mounting mechanism 106 and/or mounting elements 176 may have other fixed or releasable configurations that now known, or are subsequently developed.

In the illustrated embodiment, the product holder 100 is relatively transparent or translucent, at least a portion of the product holder 100 being made from relatively transparent materials. For example, the central L-shaped member 326 is extruded from a clear plastic material, the plates 328, 450 are injection molded using a clear plastic material, and the mounting elements 176 are clear suction cups. While the extension members 330 are formed from a metal material, the extension members 330 are relatively spaced apart from each other, and therefore, when the product holder 100 used as shown in FIG. 2, for example, the customer may be able to look through the product holder 100 when the product holder 100 is empty to see products positioned behind the product holder 100 on the cooler shelves.

In the illustrated embodiment, the product holder 100 is further configured to display one or more placards, such as product advertisements. As shown in FIG. 3, a panel 382 hangs downward from the lower surface 334 of the central L-shaped member 326. The panel 382 includes upper and lower flanges 384 such that a placard slid along the panel 382 is retained by the flanges 384. Therefore, the placard is visible to the customer when the product holder 100 is viewed from the front. For example, in the embodiment shown in FIG. 2, the placard is visible through the glass door of the cooler. Additionally, a rearward side of the rearward surface 336 of the central L-shaped member 326 also includes upper and lower flanges (not shown) that are configured to retain a placard slid along the rearward side of the rearward surface 336. Therefore, when the product holder 100 is viewed from the rear, the placard is visible the user. For example, in the embodiment shown in FIG. 2, the placard is visible to the customer when the glass door to the cooler is opened.

While particular embodiments of a product holder have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

At least the following is claimed:

1. A product holder comprising:
a support mechanism that can support one or more products;
a mounting mechanism that can be mounted to a surface; and
a depth adjustment mechanism that couples the support mechanism to the mounting mechanism, the depth adjustment mechanism being movable with reference to the support mechanism to reposition the support mechanism in a depth direction, the depth direction being generally perpendicular to the surface.

2. The product holder of claim 1, wherein the support mechanism comprises at least two telescoping members that are movable with respect to each other in a width direction to adjust a width of the support mechanism, the width direction being generally perpendicular to the depth direction.

3. The product holder of claim 1, wherein the support mechanism comprises:
a central L-shaped member having a lower surface, a rearward surface, and a plurality of channels extending through the lower and rearward surfaces in a width direction;
two side plates, each side plate being positioned on opposite sides of the central L-shaped member from the other side plate;
a plurality of extension members, each extension member having an outer end coupled to one of the side plates and an inner end positioned in one of the channels of the central L-shaped member.

4. The product holder of claim 1, wherein the mounting mechanism includes at least one suction cup.

5. The product holder of claim 1, wherein the depth adjustment mechanism includes at least two telescoping portions that are movable with respect to each other in the depth direction to reposition of the support mechanism in the depth direction.

6. The product holder of claim 1, wherein the depth adjustment mechanism includes a first pair of telescoping plates positioned on one side of the support mechanism, and a second pair of telescoping plates positioned on the other side of the support mechanism.

7. The product holder of claim 6, wherein each pair of telescoping plates includes a first plate and a second plate, the first plate being a side plate of the support mechanism and the second plate being coupled to the mounting mechanism.

8. The product holder of claim 7, wherein each first plate includes a plurality of apertures and each second plate includes a tooth that can engage one of the apertures to releasable lock the first and second plates together.

9. The product holder of claim 8, wherein each second plate further includes a deformable tab that can be actuated to remove the tooth from the aperture.

10. The product holder of claim 7, wherein each first plate includes a plurality of flanges and each second plate includes a plurality of edges, the flanges cooperating with the edges to maintain the alignment of the first and second plates during depth adjustment.

11. A product holder comprising:
a support mechanism configured to support one or more products;
a mounting mechanism configured to couple the support mechanism to a surface; and
a depth adjustment mechanism configured to enable repositioning the support mechanism in a depth direction, the depth direction being generally perpendicular to the surface.

12. The product holder of claim 11, wherein the depth adjustment mechanism couples the support mechanism to the mounting mechanism, the depth adjustment mechanism being movable so that a position of the support mechanism relative to the mounting mechanism can be adjusted in the depth direction.

13. The product holder of claim 11, wherein the support mechanism comprises:
one or more lower support portions, each lower support portion being configured to support a portion of the weight of the products;
one or more rearward support portions, each rearward support portion being configured to restrict at least some of the products from tipping rearward in the depth direction; and
one or more side support portions, each side support portion being configured to restrict at least some of the products from tipping outward in a width direction, the width direction being generally perpendicular to the depth direction.

14. The product holder of claim 11, further comprising a width adjustment mechanism configured to enable adjusting the support mechanism in a width direction, the width direction being generally perpendicular to the depth direction.

15. The product holder of claim 11, wherein the mounting mechanism is selectively releasable.

16. The product holder of claim 11, wherein the depth adjustment mechanism is incrementally adjustable so that the support mechanism can be repositioned in one of a plurality of pre-selected positions.

17. The product holder of claim 11, wherein the depth adjustment mechanism is continuously adjustable so that the support mechanism can be repositioned to any position along a range of potential depth positions.

18. The product holder of claim 11, wherein the depth adjustment mechanism includes at least two telescoping portions that are movable with respect to each other in the depth direction to reposition of the support mechanism in the depth direction.

19. The product holder of claim 11, wherein each telescoping portion is configured to maintain alignment with respect to the other telescoping portion during depth adjustment.
